(19) United States
(12) Patent Application Publication
(10) Pub. No.: US 2016/0325749 A1
(43) Pub. Date: Nov. 10, 2016

(54) METHOD AND APPARATUS FOR CONTROLLING ENTRY INTO SSC ACCORDING TO CHANGE OF ROAD GRADIENT

(71) Applicant: Hyundai Motor Company, Seoul (KR)

(72) Inventors: Hyung-Ju Lee, Yongin (KR); Kyu-Jin Jo, Suwon (KR); Seong-Kyu Park, Suwon (KR)

(21) Appl. No.: 14/935,689

(22) Filed: Nov. 9, 2015

(30) Foreign Application Priority Data
May 8, 2015 (KR) 10-2015-0064529

(51) Int. Cl. B60W 30/18; B60W 10/04; B60W 10/18

(52) U.S. Cl. CPC B60W 30/18072; B60W 10/18; B60W 10/04; B60W 2550/142; B60W 2900/00; B60W 2720/106; B60W 2710/18

(57) ABSTRACT

A method for controlling entry into a SSC based on a change of a road gradient is provided. The method includes determining whether a traveling vehicle satisfies a predetermined condition of entry into the SSC, a road gradient when the vehicle satisfies the predetermined condition of entry into SSC, and whether the determined road gradient satisfies a predetermined condition of road gradient. The change of road gradient is measured when the determined road gradient satisfies the predetermined condition of road gradient. Additionally, the method includes determining whether the measured change of road gradient satisfies a predetermined condition of change of road gradient and entering SSC when the measured change of road gradient satisfies the predetermined condition of change of road gradient.

### CROSS-REFERENCE TO RELATED APPLICATIONS

This application claims priority to Korean Patent Application No. 10-2015-0064529, filed on May 8, 2015, which is incorporated herein by reference in its entirety.

### BACKGROUND

1. Field of the Invention

The present invention relates to a method and apparatus for controlling entry into a start-stop coasting (SSC) mode based on a change of a road gradient and, more particularly, to a control method and apparatus which prevents a driver from sensing incompatibility and unnecessary entry to SSC by restricting entry to the SSC or releasing the SSC based on the change of road gradient.

2. Description of Related Art

An improvement of actual fuel efficiency is increasingly being considered. Accordingly, technology for maximizing actual fuel efficiency when traveling on a road using a driving condition of a driver, surrounding traffic, road information, etc., as well as technology for controlling vehicle systems, has been researched and developed in vehicle industry.

For example, a technique of searching and guiding an economic driving route using information technology (IT) and traffic information, a technique of guiding driving at high fuel efficiency by storing a road gradient information and previous traveling patterns, a technique of controlling charge/discharge of a battery based on a state of charge (SOC) level thereof by predicting and determining road gradient and traffic information, and a technique of selectively controlling a traveling mode such that fuel consumption is minimized based on a destination route and traffic information using map information database (DB), are being researched and developed.

One of the techniques for maximizing the fuel efficiency is an SSC technique. FIGS. 1A and 1B are diagrams for illustrating the SSC technique according to the prior art. Referring to FIGS. 1A and 1B, SSC is a technique of cutting off fuel supply to an engine (e.g., fuel cut) and cutting off power transfer to a transmission (e.g., clutch off) during coasting (see FIG. 1A). Thus, the mileage of a vehicle to which the SSC is applied increases compared to that of the conventional vehicle since engine drag torque is cut off (see FIG. 1B).

The SSC operation requirement according to the prior art does not have a limit on an angle of inclination. Accordingly, a vehicle may be accelerated due to the release of an engine brake when entering the SSC on a downhill road and a driver, which expects the operation of the engine brake, may sense incompatibility. In addition, durability of relevant parts may be deteriorated since the vehicle is rapidly decelerated due to the loss of engine torque when entering the SSC on the uphill road or frequent restart (e.g., release of SSC) is generated.

### SUMMARY

The present invention provides a method and apparatus for controlling entry into SSC based on a change of a road gradient, which prevents a driver from sensing incompatibility and unnecessary entry to SSC by restricting entry to the SSC or releasing the SSC while entering the SSC based on a road gradient.

Other objects and advantages of the present invention may be understood by the following description, and become apparent with reference to the exemplary embodiments of the present invention. Additionally, it is obvious to those skilled in the art to which the present invention pertains that the objects and advantages of the present invention may be realized by the means as claimed and combinations thereof.

In accordance with an exemplary embodiment of the present invention, a method for controlling entry into SSC based on a change of a road gradient may include determining whether a traveling vehicle satisfies a predetermined condition of entry into SSC (S100), determining a road gradient (S200) when the vehicle satisfies the predetermined condition of entry into SSC, determining whether the determined road gradient satisfies a predetermined condition of road gradient (S300), measuring a change of the road gradient (S400) when the determined road gradient satisfies the predetermined condition of road gradient, determining whether the measured change of the road gradient satisfies a predetermined condition of change of road gradient (S500), and entering SSC (S600) when the measured change of road gradient satisfies the predetermined condition of change of road gradient.

The method may further include preventing the entrance to SSC (S700) when the measured change of road gradient does not satisfy the predetermined condition of change of road gradient. In particular, when the determined road gradient does not satisfy the predetermined condition of road gradient, the vehicle may be prevented from entering the SSC mode. Additionally, this prevention may be performed when the traveling vehicle does not satisfy the predetermined condition of entry into SSC.

The predetermined condition of entry into SSC may be a condition in which an accelerator pedal and a brake pedal are not operated (e.g., disengaged) and a vehicle speed is equal to or greater than a predetermined speed. The determining of a road gradient (S200) may include measuring an acceleration of the vehicle (S210). The determining of a road gradient (S200) may further include determining whether the measured acceleration of the vehicle is equal to or less than a predetermined first reference value (S220).

Further, the determining of a road gradient (S200) may include determining whether the measured acceleration of the vehicle is equal to or greater than a predetermined second reference value (S230) when the measured acceleration of the vehicle is equal to or less than the predetermined first reference value. The road may also be determined to be a flat road (S240) when the measured acceleration of the vehicle is equal to or greater than the predetermined second reference value.

Additionally, the determining a road gradient (S200) may include determining that a road is an uphill road (S250) when the measured acceleration of the vehicle is less than the predetermined second reference value and that a road is a downhill road (S260) when the measured acceleration of the vehicle is greater than the predetermined first reference value. The determination of whether the road gradient satisfies a predetermined condition of road gradient (S300) may determine whether a road is determined to be a flat road in the determining a road gradient (S200). In accordance with another exemplary embodiment of the present invention, a storage medium may be configured to store the method for controlling entry into SSC based on a change of a road gradient.

In accordance with another exemplary embodiment of the present invention, an apparatus for controlling entry into SSC according to a change of road gradient may include a storage medium (100), a detection unit (200) configured to detect whether an accelerator pedal is operated, whether a brake pedal is operated, and a speed and acceleration of a vehicle, and a controller (300) configured to operate a vehicle component (400) by receiving information detected by the detection unit (200). The detection unit (200) may include an accelerator pedal detection sensor (210), a brake pedal detection sensor (220), a vehicle speed detection sensor (230), and a vehicle acceleration detection sensor (240). The vehicle component (400) may include an engine (410) into which fuel is injected, and a clutch (420) for coupling or decoupling the engine (410) and a transmission (T).

### BRIEF DESCRIPTION OF THE DRAWINGS

A brief description of each drawing is provided to more sufficiently understand drawings used in the detailed description of the present invention.

FIGS. 1A and 1B are diagrams illustrating a SSC technique according to the prior art;

FIGS. 2 and 3A-3C are flowcharts illustrating a method for controlling entry into SSC according to a change of road gradient in accordance with an exemplary embodiment of the present invention; and

FIGS. 4 and 5 are block diagrams illustrating an apparatus for controlling entry into SSC according to a change of road gradient in accordance with another exemplary embodiment of the present invention.

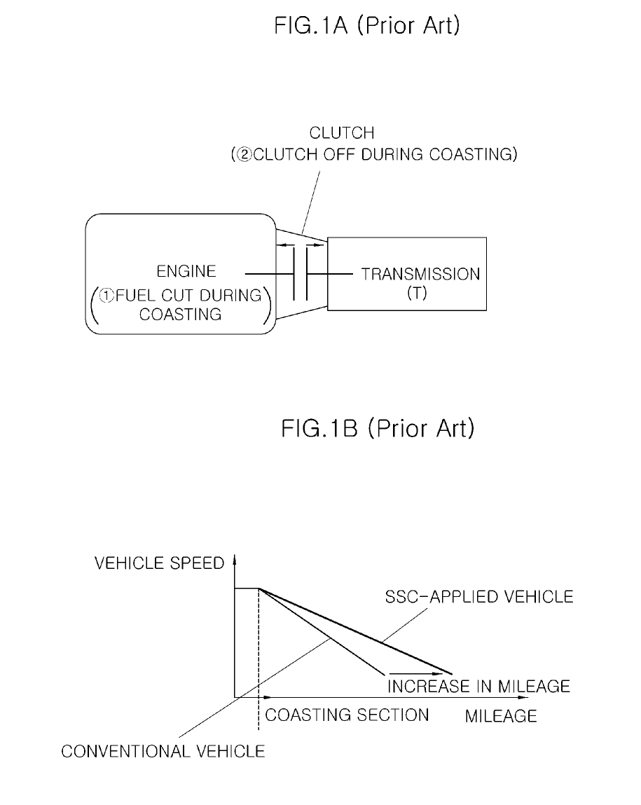

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The terms and words used in the specification and claims should not be construed as their ordinary or dictionary sense. Based on the principle that the inventor may define the appropriate concept of a term to describe his/her own invention in the best way, it should be construed as meaning and concepts for complying with the technical idea of the present invention. Accordingly, the exemplary embodiments described in the present specification and the construction shown in the drawings are nothing but exemplary embodiments of the present invention, and do not cover all the technical ideas of the invention. Thus, it should be understood that various changes and modifications may be made at the time of filing the present application. In addition, detailed descriptions of functions and constructions well known in the art may be omitted to avoid unnecessarily obscuring the gist of the present invention. Exemplary embodiments of the present invention will be described below in more detail with reference to the accompanying drawings.

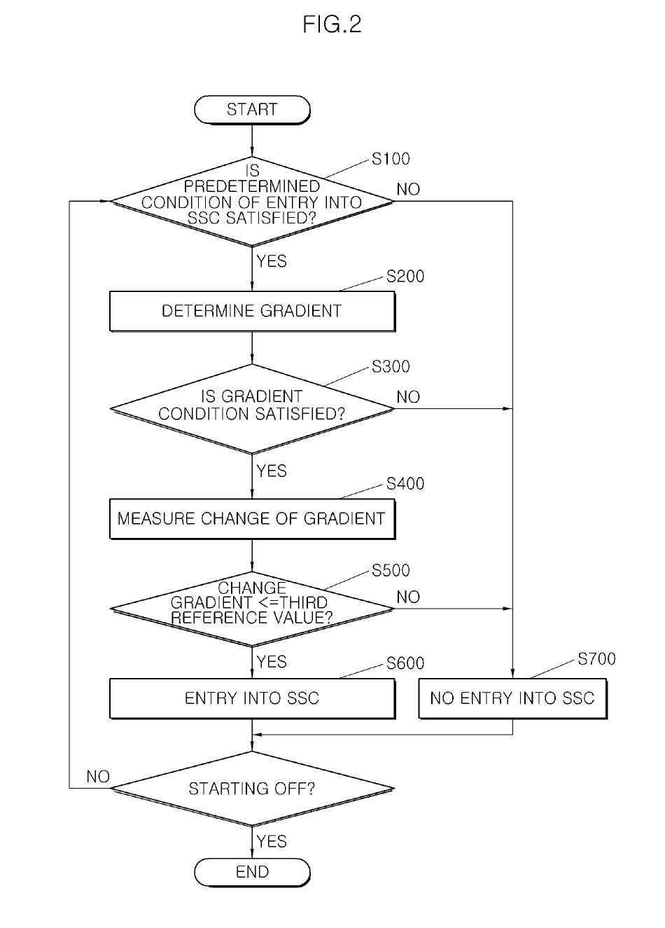

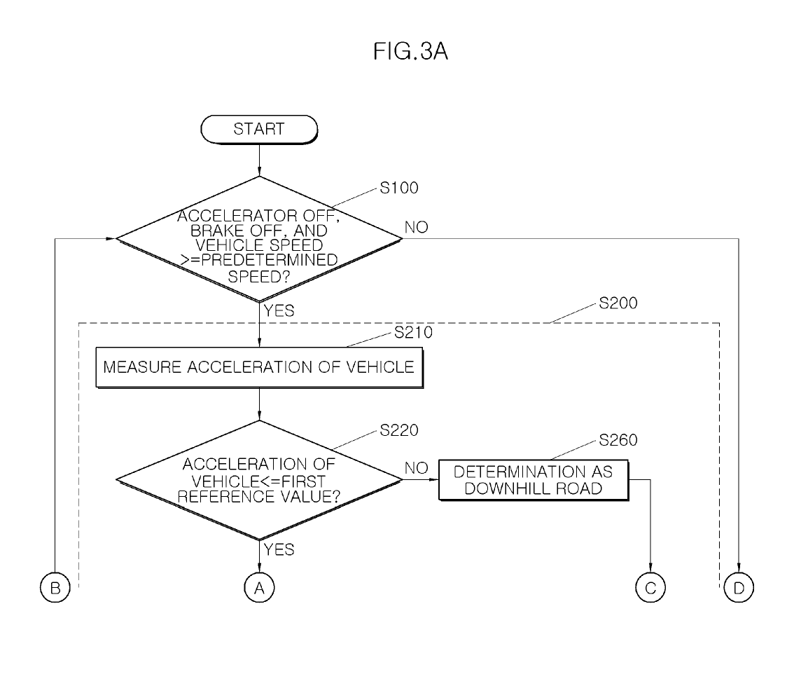

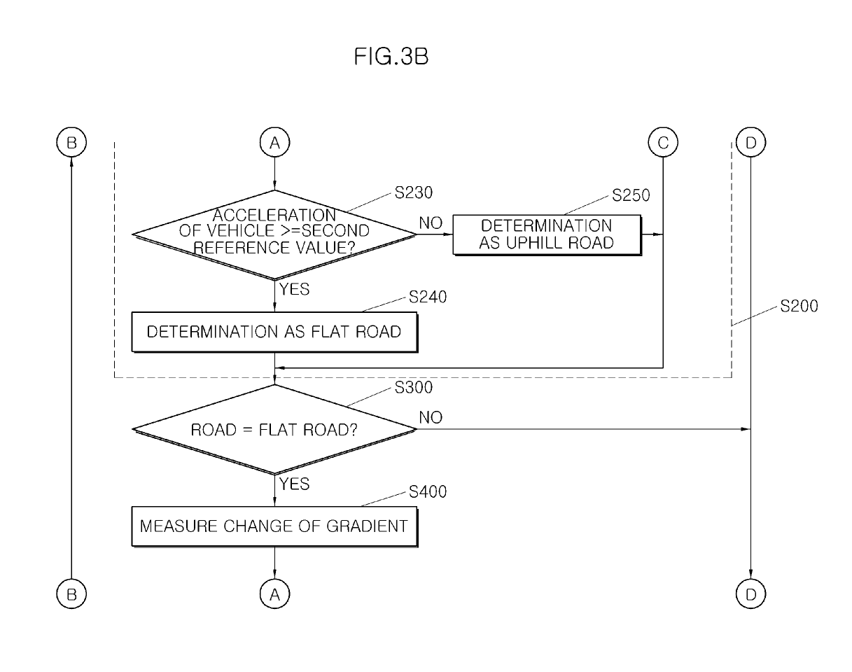

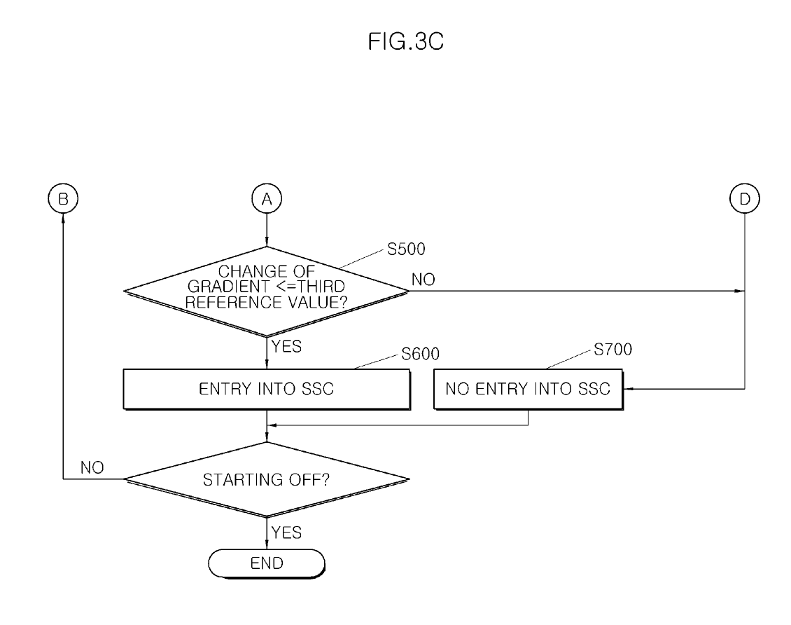

FIGS. 2 and 3 are flowcharts illustrating a method for controlling entry into SSC based on a change of a road gradient in accordance with an exemplary embodiment of the present invention. The method described herein below may be executed by a controller having a processor and a memory. Referring to FIGS. 2 and 3, the method for controlling entry into SSC based on a change of a road gradient in accordance with the exemplary embodiment of the present invention may include determining whether a traveling vehicle satisfies a predetermined condition of entry into SSC (S100), determining a road gradient when the vehicle satisfies the predetermined condition of entry into SSC (S200), \determining whether the determined road gradient satisfies a predetermined condition of road gradient (S300), measuring a change of the road gradient when the determined road gradient satisfies the predetermined condition of road gradient (S400), \determining whether the measured change of the road gradient satisfies a predetermined condition of change of road gradient (S500), and entering SSC when the measured change of road gradient satisfies the predetermined condition of change of road gradient (S600). In addition, the method may further include preventing the entry to the SSC when the measured change of road gradient does not satisfy the predetermined condition of change of road gradient (S700).

In the determination of whether a traveling vehicle satisfies a predetermined condition of entry into SSC, the predetermined condition of entry into SSC may be a condition in which an accelerator pedal and a brake pedal are not operated (e.g., disengaged) and a vehicle speed is equal to or greater than a predetermined speed. In addition, the predetermined speed may be set different based on a vehicle type. The prevention of entry into the SSC may be performed when the traveling vehicle does not satisfy the predetermined condition of entry into SSC.

In other words, it may be possible to operate the vehicle based on a driver intention by restricting the entry into SSC or releasing the SCC in the state of entering the SCC, without determining the road gradient. Additionally, in this process, fuel may be resupplied to an engine and the power of the engine may again be transferred to a transmission through the connection of a clutch. Accordingly, the vehicle may be operated to maintain the state of releasing the SSC when the traveling of the vehicle does not enter the SCC state and may be operated to release the SCC when the traveling of the vehicle enters the SCC state.

The determination of a road gradient may include measuring an acceleration of the vehicle (S210), determining whether the measured acceleration of the vehicle is equal to or less than a predetermined first reference value (S220), determining whether the measured acceleration of the vehicle is equal to or greater than a predetermined second reference value when the measured acceleration of the vehicle is equal to or less than the predetermined first reference value (S230), determining that the road is a substantially flat road when the measured acceleration of the vehicle is equal to or greater than the predetermined second reference value (S240), determining that the road is an uphill (e.g., inclined) road when the measured acceleration of the vehicle is less than the predetermined second reference value (S250), and determining that the road is a downhill road when the measured acceleration of the vehicle is greater than the predetermined first reference value (S260).

In other words, the road may be detected to be the downhill road when the measured acceleration of the vehicle is greater than the predetermined first reference value, an uphill road when the measured acceleration of the vehicle is less than the second reference value, and a substantially flat road when the measured acceleration of the vehicle is equal to or greater than the second reference value and is equal to or less than the first reference value. The first and second reference values may be set differently based on a vehicle type.

The determination of whether the determined road gradient satisfies a predetermined condition of road gradient may determine whether the road is detected as the substantially flat road. In addition, when the determined road gradient satisfies the predetermined condition of road gradient, namely, when the road is determined to be the substantially flat road, a change of the road gradient may be measured.

Additionally, when the determined road gradient does not satisfy the predetermined condition of road gradient, the SSC entry may be prevented. In other words, prevention may be performed when the road is determined to be the uphill road or the downhill road, thereby preventing the driver from sensing incompatibility due to entry into SSC and unnecessary entry to the SSC by restricting entry to the SSC or releasing the SSC in the state of entering the SSC.

In the determination of whether the measured change of road gradient satisfies a predetermined condition of change of road gradient, it may be possible to determine whether the measured change of road gradient is equal to or less than a predetermined third reference value. In other words, it may be possible to prevent the driver from sensing incompatibility due to entry into SSC and unnecessary entry to the SSC through the entry into SSC on the road having a relatively low change of road gradient.

When the measured change of road gradient satisfies the predetermined condition of change of road gradient, entry to SSC may be performed. Thus, the fuel supply to the engine may be cut off (e.g., fuel cut) and the power transfer to the transmission may be cut off (e.g., clutch off). Consequently, the mileage of the vehicle according to the present invention may be increased compared to that of the conventional vehicle in the prior art since engine drag torque may be cut off, thereby improving fuel efficiency of the vehicle. The entry to SSC may include operating the vehicle to enter the SSC when the traveling of the vehicle does not enter the SCC state and operating the vehicle to maintain the state of entering the SCC when the traveling of the vehicle enters the SCC state.

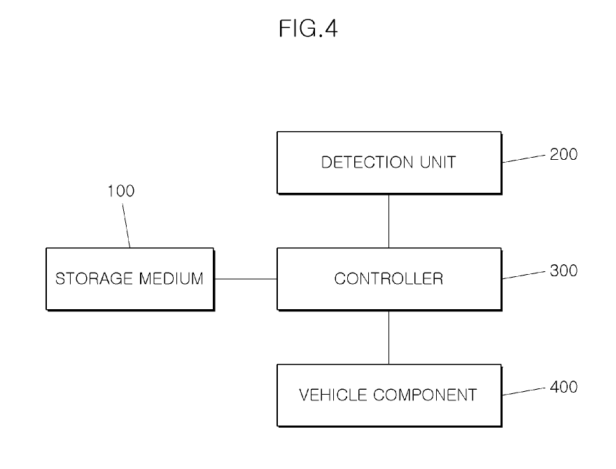

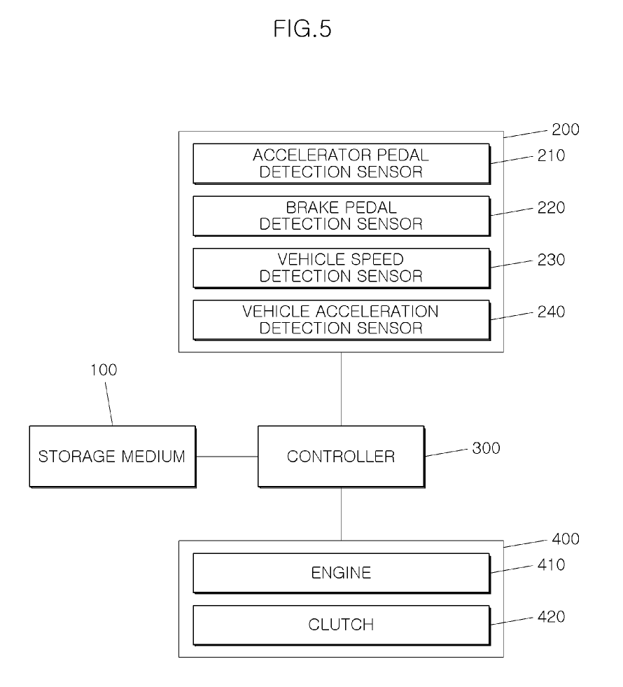

FIGS. 4 and 5 are block diagrams illustrating an apparatus for controlling entry into SSC based on a change of a road gradient in accordance with another exemplary embodiment of the present invention. Referring to FIGS. 4 and 5, the apparatus for controlling entry into SSC based on a change of a road gradient in accordance with another exemplary embodiment of the present invention may include a storage medium (e.g., a memory) 100 configured to store a method for controlling entry into SSC based on a change of a road gradient, a detection unit (e.g., one or more sensors) 200 configured to detect whether an accelerator pedal is operated (e.g., engaged), whether a brake pedal is operated (e.g., engaged), and a speed and acceleration of a vehicle, and a controller 300 configured to operate a vehicle component 400 by receiving information detected by the detection unit 200.

The detection unit 200 may include an accelerator pedal detection sensor 210, a brake pedal detection sensor 220, a vehicle speed detection sensor 230, and a vehicle acceleration detection sensor 240. The vehicle component 400 may include an engine 410 into which fuel is injected, and a clutch 420 which couples or decouples the engine 410 and a transmission T.

In accordance with the exemplary embodiments of the present invention, it may be possible to improve drivability by preventing a driver from sensing incompatibility due to entry into SSC. In addition, it may be possible to improve durability of relevant parts by preventing unnecessary entry to the SSC.

While the present invention has been described with respect to the exemplary embodiments, it will be apparent to those skilled in the art that various changes and modifications may be made without departing from the spirit and scope of the invention as defined in the following claims.

What is claimed is:

1. A method for controlling entry into a start-stop coasting (SSC) based on a change of a road gradient, comprising:
determining, by a controller, whether a traveling vehicle satisfies a predetermined condition of entry into SSC;
determining, by the controller, the road gradient when the vehicle satisfies the predetermined condition of entry into the SSC;
determining, by the controller, whether the determined road gradient satisfies a predetermined condition of road gradient;
measuring, by the controller, the change of the road gradient when the determined road gradient satisfies the predetermined condition of road gradient;
determining, by the controller, whether the measured change of road gradient satisfies a predetermined condition of change of road gradient; and
entering, by the controller, the SSC when the measured change of road gradient satisfies the predetermined condition of change of road gradient.

2. The method of claim 1, further comprising:
preventing, by the controller, entry to the SSC when the measured change of road gradient does not satisfy the predetermined condition of change of road gradient.

3. The method of claim 2, wherein prevention is performed when the determined road gradient dose not satisfy the predetermined condition of road gradient.

4. The method of claim 2, wherein the prevention is performed when the traveling vehicle dose not satisfy the predetermined condition of entry into SSC.

5. The method of claim 1, wherein the predetermined condition of entry into SSC is a condition in which an accelerator pedal and a brake pedal are disengaged and a vehicle speed is equal to or greater than a predetermined speed.

6. The method of claim 1, wherein the determination of the road gradient includes measuring an acceleration of the vehicle.

7. The method of claim 6, wherein the determination of the road gradient includes determining whether the measured acceleration of the vehicle is equal to or less than a predetermined first reference value.

8. The method of claim 7, wherein the determination of the road gradient includes determining whether the measured acceleration of the vehicle is equal to or greater than a predetermined second reference value when the measured acceleration of the vehicle is equal to or less than the predetermined first reference value.

9. The method of claim 8, wherein the determination of the road gradient includes determining that a road is a flat road when the measured acceleration of the vehicle is equal to or greater than the predetermined second reference value.

10. The method of claim 8, wherein the determination of the road gradient includes determining that a road is an uphill road when the measured acceleration of the vehicle is less than the predetermined second reference value.

11. The method of claim 7, wherein the determination of the road gradient includes determining that a road is a downhill road when the measured acceleration of the vehicle is greater than the predetermined first reference value.

12. The method of claim 1, wherein the determination of whether the road gradient satisfies a predetermined condition of road gradient determines whether a road is determined to be a flat road in the determination of road gradient.

13. An apparatus for controlling entry into a start-stop coasting (SSC) based on a change of a road gradient, comprising:
a storage medium configured to store a method for controlling entry into the SSC based on the change of the road gradient;
a detection unit configured to detect whether an accelerator pedal is engaged, whether a brake pedal is engaged, and a speed and acceleration of a vehicle; and
a controller configured to operate a vehicle component by receiving information detected by the detection unit.

14. The apparatus of claim 13, wherein the detection unit includes an accelerator pedal detection sensor, a brake pedal detection sensor, a vehicle speed detection sensor, and a vehicle acceleration detection sensor.

15. The apparatus of claim 13, wherein the vehicle component includes an engine into which fuel is injected, and a clutch for coupling or decoupling the engine and a transmission.

16. A non-transitory computer readable medium containing program instructions executed by a controller, the computer readable medium comprising:
program instructions that determine whether a traveling vehicle satisfies a predetermined condition of entry into a start-stop coasting SSC;
program instructions that determine a road gradient when the vehicle satisfies the predetermined condition of entry into the SSC;
program instructions that determine whether the determined road gradient satisfies a predetermined condition of road gradient;
program instructions that measure the change of the road gradient when the determined road gradient satisfies the predetermined condition of road gradient;
program instructions that determine whether the measured change of road gradient satisfies a predetermined condition of change of road gradient; and
program instructions that enter the SSC when the measured change of road gradient satisfies the predetermined condition of change of road gradient.

17. The non-transitory computer readable medium of claim 16, further comprising:
program instructions that prevent entry to the SSC when the measured change of road gradient does not satisfy the predetermined condition of change of road gradient.

18. The non-transitory computer readable medium of claim 16, wherein the predetermined condition of entry into SSC is a condition in which an accelerator pedal and a brake pedal are disengaged and a vehicle speed is equal to or greater than a predetermined speed.

19. The non-transitory computer readable medium of claim 16, wherein the determination of the road gradient includes measuring an acceleration of the vehicle.
